(19) United States
(12) Patent Application Publication
(10) Pub. No.: US 2003/0216991 A1
(43) Pub. Date: Nov. 20, 2003

(54) Systems and methods for collecting financial information associated with a plurality of properties

(75) Inventor: Tolin Baker, Scottsdale, AZ (US)

Correspondence Address: BUCKLEY, MASCHOFF, TALWALKAR, & ALLISON, 5 ELM STREET, NEW CANAAN, CT, 06840, US

(73) Assignee: General Electric Capital Corporation, Stamford, CT (US)

(21) Appl. No.: 10/063,838

(22) Filed: May 17, 2002

(51) Int. Cl. G06F 17/60

(52) U.S. Cl. 705/36

(57) ABSTRACT

Systems and methods are provided to collect financial information associated with a plurality of properties. According to one embodiment, a first set of financial statement values associated with a first property is received. A second set of financial statement values associated with a second property is also received. At least one of the first set of financial statement values is evaluated based on evaluation information associated with the first property, and an indication of a potential error is provided based on the evaluation.

### BACKGROUND OF INVENTION

1. Field

The present invention relates to financial statements. In particular, the present invention relates to systems and methods for collecting financial information associated with a plurality of properties.

2. Background

A creditor can extend credit to a property owner via a credit account. For example, a creditor may extend credit to the owner of a retail store. Of course, there is always some risk that a property will fail to provide payments associated with a credit account. For example, an owner may become bankrupt or simply lack sufficient funds to provide payments in a timely manner. In this case, the creditor can suffer a loss associated with some, or even all, of the credit that had been extended to the property owner. This risk can be especially serious with respect to commercial accounts because of the significant amount of credit that is often extended via such accounts.

If a creditor could identify the property owners who are more likely to have such problems, the accounts associated with those owners could be closely monitored. For example, the creditor might quickly contact a high risk owner when a delayed payment is detected. Moreover, the creditor might be able to re-schedule or otherwise adjust payments to reduce the risk of suffering a loss because of a high risk owner. Note that it may be impractical for a creditor to quickly contact and/or negotiate with each and every owner who delays a payment (e.g., the creditor may be extending credit to hundreds or thousands of property owners).

It is known that a creditor may receive financial statements from property owners (e.g., balance sheets, cash flow statements, and/or profit and loss statements). The financial information in these statements might be used, for example, to detect if a property owner is having difficulty with a property (e.g., as reflected by declining sales at his or her restaurant).

A number of problems can arise, however, when financial statements are received from property owners. For example, different property owners will typically present financial statements in different ways. For example, one property owner might include values for both “food cost” and “beverage cost” while another property owner merely uses a single “cost” value. Such differences can make the entry of financial information a difficult, time-consuming, and error prone task (e.g., because someone needs to correctly interpret the values). Moreover, such differences can hamper a comparison of properties associated with different property owners.

In addition, a creditor generally receives a printed financial statement from a property owner. An operator associated with the creditor must then manually enter each financial statement value (e.g., by typing the values in via a computer keyboard). Note that the creditor may receive a large number of printed financial statements (e.g., thousands of printed financial statements may be received each month), and each financial statement may contain a large number of values (e.g., a statement may contain forty values). As a result, the manual entry of these values can include a significant number of errors (e.g., an operator may type “$200” instead of “$2,000”).

Moreover, a single property owner may provide financial statements for a number of different properties (e.g., a property owner may own ten different restaurants). As a result, the manual entry of some information may be redundant. For example, all of the financial statements from the same property owner may cover the same period of time (e.g., the second quarter). However, the operator may need to enter this information (e.g., “Q2”) ten separate times.

### SUMMARY OF INVENTION

To alleviate problems inherent in the prior art, the present invention introduces systems and methods for collecting financial information associated with a plurality of properties.

According to one embodiment, a first set of financial statement values associated with a first property is received. A second set of financial statement values associated with a second property is also received. At least one of the first set of financial statement values is evaluated based on evaluation information associated with the first property, and an indication of a potential error is provided based on the evaluation.

According to another embodiment, a set of financial statement values associated with a first property is received, and at least one of the financial statement values is applied to a second property, wherein the first property and the second property are associated with a single property owner.

According to still another embodiment, first and second sets of financial statement values, associated with first and second properties, respectively, are electronically received. The sets are then translated into a standard format.

One embodiment of the present invention comprises: means for receiving a first set of financial statement values associated with a first property; means for receiving a second set of financial statement values associated with a second property; means for evaluating at least one of the first set of financial statement values based on evaluation information associated with the first property; and means for providing an indication of a potential error based on said evaluation.

Another embodiment comprises: means for receiving a set of financial statement values associated with a first property; and means for applying at least one of the financial statement values to a second property, wherein the first property and the second property are associated with a single property owner.

Still another embodiment comprises: means for electronically receiving a first set of financial statement values associated with a first property; means for electronically receiving a second set of financial statement values associated with a second property; means for translating the first set of financial statement values into a standard format; and means for translating the second set of financial statement values into the standard format.

A technical effect of some embodiments of the present invention is to provide a computer adapted to efficiently collecting financial information associated with a plurality of properties.

With these and other advantages and features of the invention that will become hereinafter apparent, the invention may be more clearly understood by reference to the following detailed description of the invention, the appended claims, and the drawings attached herein.

### BRIEF DESCRIPTION OF DRAWINGS

FIG. 1 is a block diagram of a financial tracking system according to some embodiments of the present invention.

FIG. 2 is a flow chart of a financial tracking method according to some embodiments of the present invention.

FIG. 3 illustrates a financial tracking display according to an embodiment of the present invention.

FIG. 4 is a tabular representation of a portion of a property database according to an embodiment of the present invention.

FIG. 5 is a tabular representation of a portion of a template database according to an embodiment of the present invention.

FIG. 6 is a tabular representation of a portion of a financial information database according to an embodiment of the present invention.

FIG. 7 is a flow chart of an error checking method according to some embodiments of the present invention.

FIG. 8 illustrates an error checking display according to an embodiment of the present invention.

FIG. 9 is a flow chart of a group entry method according to some embodiments of the present invention.

FIG. 10 illustrates a group entry display according to an embodiment of the present invention.

FIG. 11 is a flow chart of an electronic financial tracking method according to some embodiments of the present invention.

FIG. 12 is a block diagram of a financial tracking network according to some embodiments of the present invention.

### DETAILED DESCRIPTION

Some embodiments of the present invention are directed to systems and methods for collecting “financial information.” As used herein, the phrase “financial information” may refer to, for example, any information that describes or is otherwise associated with the financial status of a business. For example, financial information may refer to values that appear in a financial statement (e.g., values that appear in a balance sheet, a cash flow statement, and/or a profit and loss statement).

According to some embodiments, financial information is associated with a “property.” As used herein, the term “property” may refer to, for example, one or more businesses (e.g., a retail store, an office building, or a franchisee). Similarly, a “property owner” may be any entity (e.g., a person or a business) that owns or otherwise has an interest in a property.

Moreover, as used herein, the phrase “commercial credit account” may refer to any account that is used to extend credit to a property owner. For example, credit may be extended to a business in connection with a commercial equipment purchase or lease (e.g., for restaurant equipment).

Financial Tracking System

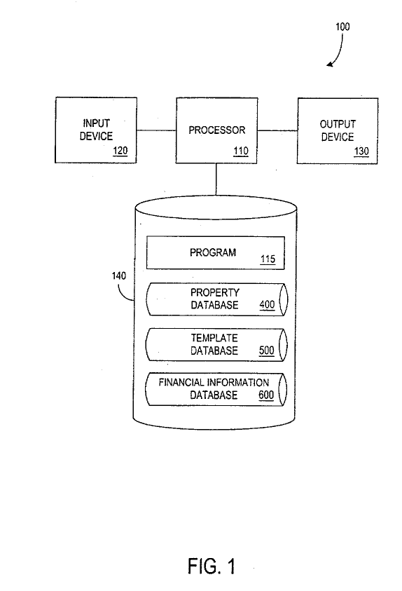

Turning now in detail to the drawings, FIG. 1 illustrates a financial tracking system 100 according to some embodiments of the present invention. The financial tracking system 100 includes a processor 110, such as one or more INTEL® Pentium® processors.

The processor 110 is in communication with an input device 120. The input device 120 may comprise, for example, a keyboard, a mouse or other pointing device, a microphone, an infrared port, a docking station, and/or a touch screen. Such an input device 120 may be used, for example, by an operator to manually enter financial statement values from a printed financial statement.

The processor 110 is also in communication with an output device 130. The output device 130 may comprise, for example, a display (e.g., a computer monitor), a speaker, and/or a printer. The output device 130 may be used, for example, to provide an analysis of financial information and/or an indication of a potential error to an operator.

The processor 110 is also in communication with a storage device 140. The storage device 140 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 140 stores one or more programs 115 for controlling the processor 110. The processor 110 performs instructions of the programs 115, and thereby operates in accordance with the present invention as described herein.

Financial Tracking Method

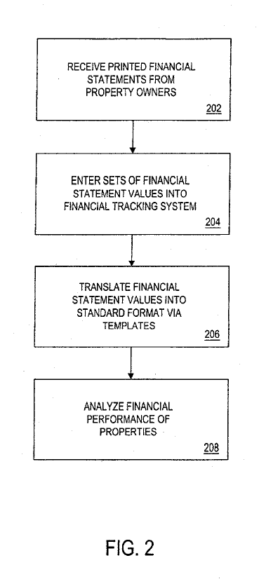

According some embodiment of the present invention, the financial tracking system 100 facilitates the collection of financial information. In particular, FIG. 2 is a flow chart of a method that may be performed by the financial tracking system 100 according to some embodiments of the present invention. The flow charts in FIG. 2 and the other figures described herein do not imply a fixed order to the steps, and embodiments of the present invention can be practiced in any order that is practicable.

At 202, printed financial statements are received from various property owners. For example, property owners may submit financial statements to a creditor on a quarterly basis. The financial statements may comprise, for example, balance sheets, cash flow statements, and/or profit and loss statements.

At 204, sets of financial statement values are entered into the financial tracking system 100 (e.g., by having an operator manually enter values from the printed financial statements via the input device 120). In the case of a balance sheet, the financial statement values may include, for example, current assets (e.g., cash, accounts receivables, and inventor), fixed assets, liabilities (e.g., accounts payable, taxes payable, and accrued wages payable), and/or capital associated with a property.

In the case of a cash flow statement, the financial statement values may include a cash balance, cash inflows, and cash outflows. In the case of a profit and loss statement, the financial statement values may include, for example, revenue (e.g., gross sales), cost of goods, expenses (e.g., advertising, payroll, and maintenance), and/or a net income or loss associated with a property.

Because financial statements are received from a number of different property owners, however, the types of values that are included in each statement may vary. For example, one property owner might include values for “salaries,” “overtime,” “bonuses,” and “management” while another property owner simply lists a single “labor cost” value. Such differences can make the entry of financial information a difficult, time-consuming, and error prone task as well as hamper a comparison of properties associated with different property owners.

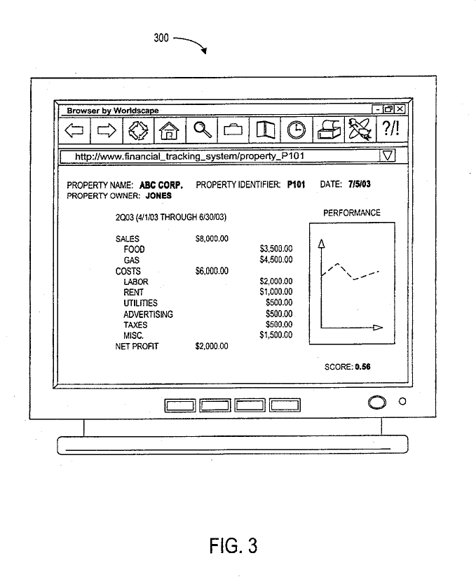

According to some embodiments of the present invention, the financial tracking system 100 translates financial statement values into a standard format. For example, FIG. 3 illustrates a financial tracking display 300 that may be used to enter financial statement values according to one embodiment of the present invention. In particular, according to this embodiment, a financial statement template may be defined for each property owner (or for each property). The template may indicate, for example, that “salaries,” “overtime,” “bonuses,” and “management” values will be entered for a particular property. The financial tracking system 100 may then combine these values into a standard “labor cost” value.

Referring to FIG. 3, an operator may use the display 300 to manually enter the second quarter food sales (i.e., $3,500) and gas sales (i.e., $4,500) from a profit and loss statement. The values may then be combined by the financial tracking system 100 into a standard “sales” value. When the display 300 is used to enter values for a different property, other sales values may be displayed and entered (e.g., “drinks,” “breakfast food,” “lunch food,” and “dinner food” values).

According to some embodiments, the display 300 is dynamically updated while information is entered by an operator. For example, when “labor” is selected another frame may appear in the display 300 to let the operator enter particular values that will appear on the printed financial statement (e.g., “salaries,” “overtime,” “bonuses,” and “management” values).

The financial statement values may be translated into a standard format at 206. For example, the financial tracking system 100 may combine multiple values, adjust values, and/or adjust time periods associated with a financial statement in accordance with an appropriate template.

At 208, the financial performance of a property may be analyzed. The analysis may comprise, for example, a regression analysis of a store's financial statement values that can be used to predict the store's future financial performance. The display 300 shown in FIG. 3 includes a chart that illustrates the result of such a financial performance analysis for a property. Similarly, a performance score for a property may be calculated and presented via the display 300.

In this way, the current performance of the property may be compared to the property's past performance and/or the performance of other properties (e.g., similar types of businesses or other properties within a particular geographic location). Such an analysis may be used, for example, to monitor a commercial credit account (or portfolio of accounts) and/or to evaluate a potential credit account deal (e.g., associated with a number of related properties).

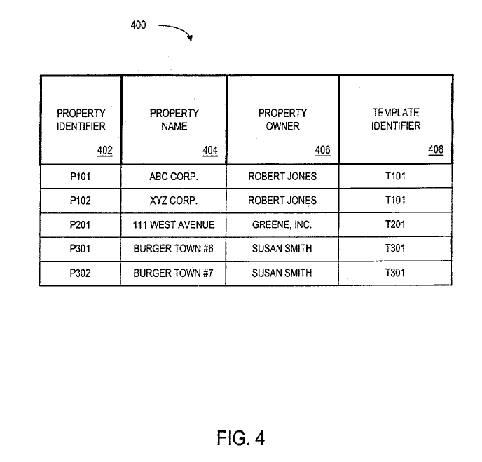

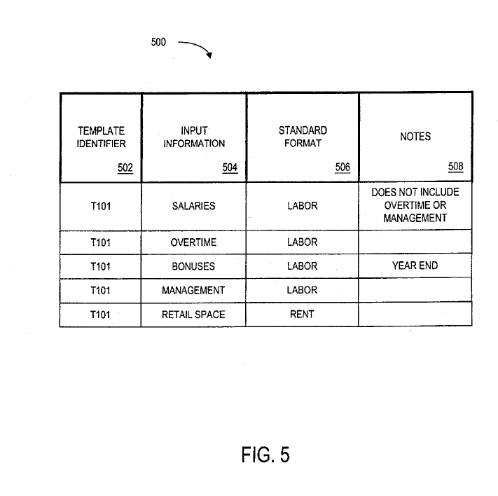

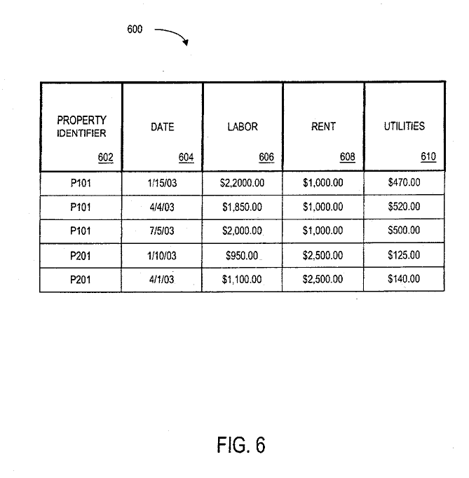

Referring again to FIG. 1, the storage device 140 also stores a property database 400 (described with respect to FIG. 4), a template database 500 (described with respect to FIG. 5), and a financial information database 600 (described with respect to FIG. 6). Examples of databases that may be used in connection with the financial tracking system 100 will now be described in detail with respect to FIGS. 4 through 6. The illustrations and accompanying descriptions of the databases presented herein are exemplary, and any number of other database arrangements could be employed besides those suggested by the figures.

Property Database

Referring to FIG. 4, a table represents the property database 400 that may be stored at the financial tracking system 100 according to an embodiment of the present invention. The table includes entries identifying properties (e.g., associated with commercial credit accounts). The table also defines fields 402, 404, 406, 408 for each of the entries. The fields specify: a property identifier 402, a property name 404, a property owner 406, and a template identifier 408. The information in the property database 400 may be created and updated, for example, based on information received from a property owner and/or an operator via the input device 120.

The property identifier 402 may be, for example, an alphanumeric code associated with a particular property (e.g., a restaurant). The property name 404 describes the property, and property owner 406 defines who owns the property (e.g., a person or business). Note that a single property owner 406 may be associated with a number of different properties.

The template identifier 408 indicates which template should be used to enter and/or translate financial statement values associated with the property (or property owner). Other information may also be stored in the property database 400 as appropriate (e.g., a property address, a password, and/or an electronic mail message identifier). Template Database

Referring to FIG. 5, a table represents the template database 500 that may be stored at the financial tracking system 100 according to an embodiment of the present invention. The table includes entries identifying templates may be used to enter and/or translate financial statement values. The table also defines fields 502, 504, 506, 508 for each of the entries. The fields specify: a template identifier 502, input information 504, standard format 506, and notes 508. The information in the template database 500 may be created and updated, for example, based on information received from an operator (e.g., after the operator reviews an initial financial statement when a commercial credit account is established for the property). According to another embodiment, some or all of the information is automatically generated by the financial tracking system 100 (e.g., based on a sample financial statement received from a property owner).

The template identifier 502 may be, for example, an alphanumeric code associated with a particular template and may be based on, or associated with, the template identifier 408 stored in the property database 400.

The input information 504 defines information that a property owner will include on a financial statement, and the standard format 506 defines how the input information 504 should be handled by the financial tracking system 100. For example, as illustrated by the first four entries in FIG. 5, each of the “salaries,” “overtime,” “bonuses,” and “management” input information 504 should be translated as “labor” in the standard format 506. The notes 508 may explain or otherwise provide further information about the input information 504 and/or the standard format 506.

Only of a portion of the information that might be associated with a template is illustrated in FIG. 5 (e.g., an actual template could be associated with a large number of financial statement values).

Financial Information Database

Referring to FIG. 6, a table represents the financial information database 600 that may be stored at the financial tracking system 100 according to an embodiment of the present invention. The table includes entries financial statement values that have been received from property owners. The table also defines fields 602, 604, 606, 608, 610 for each of the entries. The fields specify: a property identifier 602, a date 604, labor 606, rent 608, and utilities 610. The information in the financial information database 600 may be created and updated, for example, based on information received from a property owner and/or an operator.

The property identifier 602 may be, for example, an alphanumeric code associated with a particular property and may be based on, or associated with, the property identifier 402 stored in the property database 400. The date 604 indicates a period of time associated with financial information (e.g., a month, a quarter, a date of receipt, or a date of entry). The labor 606, the rent 608, and the utilities 610 represent financial statement values that have been received with respect to the property (e.g., and have been entered and/or translated into a standard format). Note that only some of the values that might be associated with a financial statement are illustrated in FIG. 5.

Financial Tracking System Error Checking

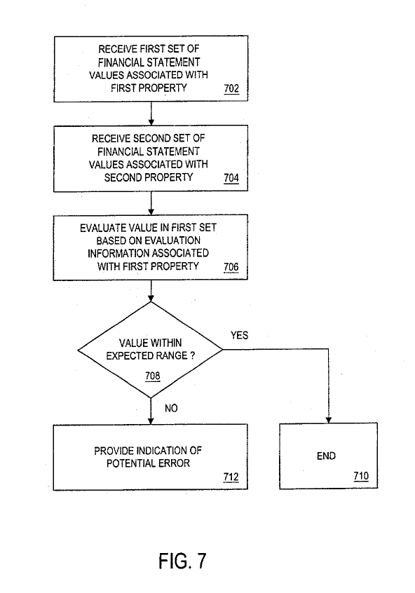

FIG. 7 is a flow chart of an error checking method according to some embodiments of the present invention. The method may be performed, for example, by the financial tracking system 100.

At 702, a first set of financial statement values associated with a first property are received, and a second set of financial statement values associated with a second property are received at 704. The sets of financial statement values may be received, for example, from different property owners (e.g., property owners who are associated with commercial credit accounts, existing loans, and/or potential loan deals).

The financial statement values may represent any type of financial information, such as sales information, profit (or loss) information, cost information, asset information, and/or liability information associated with a property (e.g., a retail store or a franchisee).

According to some embodiments, the sets of financial statement values are received via printed financial statements. In this case, an operator may manually enter the sets of financial statement values in accordance with the printed financial statements. Note that a large number of printed financial statements may be received, and each financial statement may contain a large number of values. As a result, the manual entry of these values may result in incorrect information being received by the financial tracking system 100 (e.g., an operator may type “$200” instead of “$2,000”).

In view of this possibility, at least one of the first set of financial statement values are evaluated at 706 based on evaluation information associated with the first property. For example, the evaluation information may be a prior financial statement value associated with the first property. In this case, the evaluation may comprise comparing the financial statement value to the prior financial statement value (e.g., the financial tracking system 100 may compare a new value with an average of the last three values stored in the financial information database 600). Note that the evaluation might occur before or after translation to a standard format is performed (e.g., in accordance with the template database 500).

According to another embodiment, the evaluation information is a financial statement value associated with a similar property (e.g., another store in the same geographic location). In this case, the evaluation may comprise comparing the financial statement value to the financial statement value associated with the similar property.

According to some embodiments, a plurality of pre-determined rules are executed during the evaluation. For example, instead of simply comparing a current “cost of goods sold” value with a prior cost of goods sold value, the financial tracking system 100 may calculate the cost of goods sold as a percentage of a total sale value and use that information for the evaluation.

If the value is within the expected range at 708 (e.g., the value may be allowed to be within 15% of an expected value), the process ends at 710. If the value is not within the expected range at 708, an indication of a potential error is provided at 712 based on the evaluation. For example, the financial tracking system 100 may display the indication (e.g., via the output device 130) to the operator who is manually entering information from a printed financial statement.

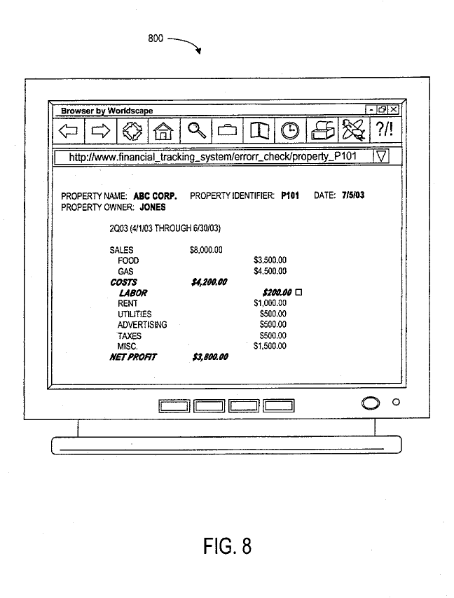

By way of example, FIG. 8 illustrates an error checking display 800 according to an embodiment of the present invention. In this case, the financial tracking system 100 has determined that the labor value of “$200.00” is potentially wrong (e.g., because the average labor value for that property during the past year is “$1,925.00”). As a result, the labor value is highlighted (e.g., as indicated by bold, italic text in FIG. 8). Note that other values which are calculated based on the labor value are also highlighted (e.g., the costs and net profit values).

The operator may then review the potential error and make any changes as appropriate. For example, the operator might consult the printed financial statement and realize that that the labor value is really “$2,000.00” (and adjust the error checking display 800). According to some embodiments, the operator may instead indicate that a potential error is actually correct. For example, the operator may select the box next to the labor value to indicate that the labor value is, in fact, only “$200.00.” According to some embodiments, at least one prior financial statement value associated with the first property is displayed to the operator (e.g., to help the operator understand why the value is considered to be a potential error).

Financial Tracking System Group Entry

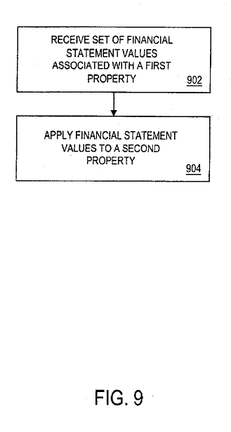

FIG. 9 is a flow chart of a group entry method according to some embodiments of the present invention. The method may be performed, for example, by the financial tracking system 100.

At 902, a set of financial statement values associated with a first property is received. The set of financial statement values may be received, for example, from a property owner via a printed financial statements. In this case, an operator may manually enter the set of financial statement values in accordance with the statement. Note that a single property owner may provide financial statements for a number of different properties (e.g., a property owner may own ten different restaurants). As a result, the manual entry of some information may be redundant. For example, all of the financial statements from the same property owner may cover the same period of time (e.g., the second quarter).

In view of this, at least one of the financial statement values is applied to a second property at 904 (e.g., another property associated with the same property owner). For example, the financial tracking system 100 may retrieve information from the property database 400 to determine if a financial statement value might be applied to another property (e.g., having the same property owner 406).

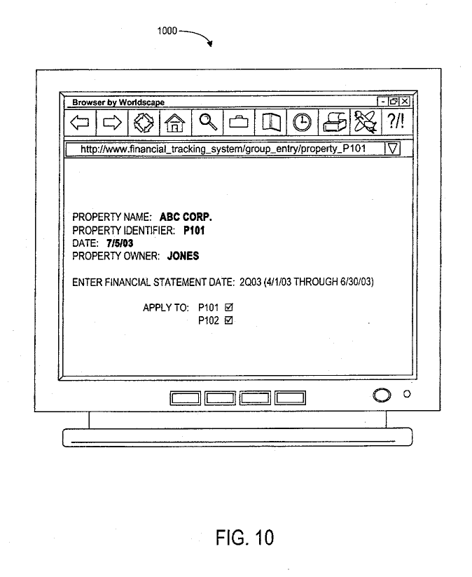

FIG. 10 illustrates a group entry display 1000 according to an embodiment of the present invention. In this case, the operator can select which properties (i.e., having property identifiers of “P101” and/or “P102”) will receive financial information for the second quarter.

Electronic Financial Tracking

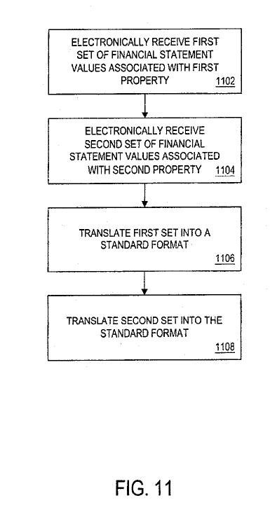

FIG. 11 is a flow chart of an electronic financial tracking method according to some embodiments of the present invention. The method may be performed, for example, by the financial tracking system 100.

At 1102 and 1104, a first set of financial statement values associated with a first property and a second set of financial statement values associated with a second property are electronically received. That is, the information may be received via an electronic file (e.g., a MICROSOFT® EXCEL spreadsheet), a Web site, or an electronic mail message. That is, the financial tracking system 100 may receive the values without having an operator manually enter the information from a printed financial statement.

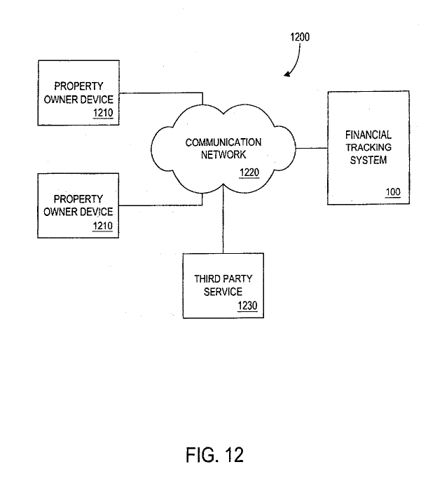

FIG. 12 is a block diagram of such a financial tracking network 1200 according to some embodiments of the present invention. As can be seen, a number of property owner devices 1210 communicate with the financial tracking system 100 via a communication network 1220. The communication network 1220 may comprise, for example, a Local Area Network (LAN), a Metropolitan Area Network (MAN), a Wide Area Network (WAN), a proprietary network, a Public Switched Telephone Network (PSTN), a Wireless Application Protocol (WAP) network, or an Internet Protocol (IP) network such as the Internet, an intranet or an extranet.

The financial tracking system 100 and the property owner devices 1210 may be any devices capable of performing the various functions described herein. The financial tracking system 100 may be associated with, for example, a Web server adapted to perform calculations, analyze information, and provide results in a periodic or substantially real-time fashion. A property owner device 1210 may be, for example, a Personal Computer (PC) adapted to run a Web browser application (e.g., the INTERNET EXPLORER® application available from MICROSOFT®), a portable computing device such as a laptop computer or a Personal Digital Assistant (PDA), and/or a wireless device.

Note that the devices shown in FIG. 12 need not be in constant communication. For example, the financial tracking system 100 may communicate with the property owner devices 1210 on an as-needed or periodic basis. Moreover, although a single financial tracking system 100 is shown in FIG. 1, any number of these devices may be included in the financial tracking network 1200. Similarly, a single device may act as both a financial tracking system 100 and a property owner devices 1210 (e.g., a property owner's PC might translate financial statement value into a standard format before transmitting the information to the financial tracking system 100).

The financial tracking system 100 may also exchange information with one or more third party services 1230, such as a service that provides business information reports or credit scores (e.g., EXPERIAN® or D&B, INC.®).

Referring again to FIG. 11, the first and second sets of financial statement values are translated into a standard format at 1106 and 1108. For example, the financial tracking system 100 may receive a set of financial values associated with a particular property identifier 402. The appropriate template identifier 408 may then be retrieved from the property database 400. This information may then be used to determine a standard format 506 for input information 504 in accordance with the information in the template database 500 (e.g., a plurality of financial statement values might be combined into a single value). After translation, the information may then be stored in the financial information database 600.

Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

In some of the embodiments described herein, financial statement values are either (i) manually entered by an operator into the financial tracking system 100 or (ii) received electronically. Note, however, that financial statement values may be received in any number of other ways in accordance with the present invention. For example, a printed financial statement may be electronically scanned and the financial statement values may be determined via an Optical Character Recognition (OCR) process. As another example, financial statement values may be received from a property owner via a telephone call center.

In another embodiment, the information collected via the financial tracking system 100 is used in connection with account collection activity. For example, a monthly watch list of high risk commercial credit accounts may be used to prioritize and focus collection activity on those property owners having the highest risk. Of course, other types of lists may also be generated. For example, a list of the highest risk accounts in a particular geographic region or industry may be generated. Similarly, a list including only newly risky accounts may be generated (e.g., accounts that were previously identified as high risk would not be included on such a list).

According to still another embodiment, the scoring information generated by the financial tracking system 100 is used in connection with a credit decision engine. For example, an property owner may approach a creditor and ask to open a new commercial credit account (e.g., in order to purchase a new truck). The creditor may then use the collected financial information to decide whether or not the owner's request will be granted.

Similarly, the information collected via the financial tracking system 100 might be used to determine an amount of credit that can be extended to a property owner. For example, financial information associated with a property may be used to determine that the owner can automatically access a $10,000 line of credit.

In another embodiment, the collected information is used to ensure compliance with credit policy rules and guidelines (e.g., rules established by a chief risk officer). For example, risk managers may be authorized to extend only a pre-determined amount of credit to owners having a particular risk score. If the property owner has (or is seeking) credit over that amount, the financial tracking system 100 may automatically notify the risk manager's supervisor (e.g., a party who is authorized to extend larger amounts of credit).

According to still another embodiment, the information collected by the financial tracking system 100 is used to monitor portfolios. For example, the financial tracking system 100 may determine risk information associated with a portfolio of commercial credit accounts.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A method of collecting financial information, comprising:
receiving a first set of financial statement values associated with a first property;
receiving a second set of financial statement values associated with a second property;
evaluating at least one of the first set of financial statement values based on evaluation information associated with the first property; and
providing an indication of a potential error based on said evaluation.

2. The method of claim 1, wherein the first set of financial statement values is received from a first property owner and the second set of financial statement values is received from a second property owner.

3. The method of claim 2, wherein at least one property owner is associated with at least one of: (i) a commercial credit account, (ii) an existing loan, and (iii) a potential loan deal.

4. The method of claim 2, wherein said receiving comprises:
receiving printed financial statements; and
manually entering the sets of financial statement values in accordance with the printed financial statements.

5. The method of claim 2, wherein said receiving comprises:
electronically receiving the sets of financial statement values.

6. The method of claim 5, wherein said receiving is performed via at least one of:
(i) an electronic file, (ii) a Web site, and (iii) an electronic mail message.

7. The method of claim 1, wherein at least one financial statement value is associated with at least one of: (i) sales information, (ii) profit information, (iii) loss information, (iv) cost information, (v) asset information, and (vi) liability information.

8. The method of claim 1, wherein at least one property is associated with at least one of: (i) a retail store, and (ii) a franchisee.

9. The method of claim 1, wherein the evaluation information is a prior financial statement value associated with the first property and said evaluation comprises:
comparing the financial statement value to the prior financial statement value.

10. The method of claim 1, wherein the evaluation information is a financial statement value associated with a similar property and said evaluation comprises:
comparing the financial statement value to the financial statement value associated with the similar property.

11. The method of claim 1, wherein said evaluation comprises:
executing a plurality of pre-determined rules.

12. The method of claim 1, wherein said providing comprises:
displaying the indication to an operator.

13. The method of claim 12, wherein said displaying further comprises:
displaying at least one prior financial statement value associated with the first property.

14. The method of claim 1, further comprising:
receiving from an operator: (i) an indication that a financial statement value is correct or (ii) an adjusted financial statement value.

15. The method of claim 1, further comprising:
translating the first set of financial statement values into a standard format; and
translating the second set of financial statement values into the standard format.

16. The method of claim 15, wherein said translations are performed in accordance with templates associated with the respective properties.

17. The method of claim 16, wherein a template combines a plurality of financial statement values into a single value.

18. The method of claim 1, further comprising:
analyzing a financial performance of the first property based on prior financial statement values associated with the first property.

19. The method of claim 1, further comprising:
analyzing a financial performance of the first property based on prior financial statement values associated with a similar property.

20. An apparatus, comprising:
a processor; and
a storage device in communication with said processor and storing instructions adapted to be executed by said processor to:
receive a first set of financial statement values associated with a first property;
receive a second set of financial statement values associated with a second property;
evaluate at least one of the first set of financial statement values based on evaluation information associated with the first property; and
provide an indication of a potential error based on said evaluation.

21. The apparatus of claim 20, wherein said storage device further stores at least one of: (i) a property database, (ii) a template database, and (iii) a financial information database.

22. The apparatus of claim 20, further comprising:
a communication device coupled to said processor and adapted to communicate with at least one of: (i) an operator terminal, (ii) a property owner device, and (iii) a third-party service.

23. A medium storing instructions adapted to be executed by a processor to perform a method of collecting financial information, said method comprising:
receiving a first set of financial statement values associated with a first property;
receiving a second set of financial statement values associated with a second property;
evaluating at least one of the first set of financial statement values based on evaluation information associated with the first property; and
providing an indication of a potential error based on said evaluation.

24. A method of collecting financial information, comprising:
receiving a set of financial statement values associated with a first property; and
applying at least one of the financial statement values to a second property, wherein the first property and the second property are associated with a single property owner.

25. The method of claim 24, wherein said receiving comprises:
receiving a printed financial statement; and
manually entering the set of financial statement values in accordance with the printed financial statement.

26. A method of collecting financial information, comprising:
electronically receiving a first set of financial statement values associated with a first property;
electronically receiving a second set of financial statement values associated with a second property;
translating the first set of financial statement values into a standard format; and
translating the second set of financial statement values into the standard format.

27. The method of claim 26, wherein said receiving is performed via at least one of:
(i) an electronic file, (ii) a Web site, and (iii) an electronic mail message.

28. The method of claim 26, wherein said translations are performed in accordance with templates associated with the respective properties.

29. The method of claim 28, wherein a template combines a plurality of financial statement values into a single value.
